(19) United States
(12) Patent Application Publication
(10) Pub. No.: US 2018/0244899 A1
(43) Pub. Date: Aug. 30, 2018

(54) Flame-Retardant Polyamide Composition

(71) Applicant: CLARIANT INTERNATIONAL LTD., Muttenz (CH)

(72) Inventors: Sebastian Hoerold, Diedorf (DE); Harald Bauer, Kerpen (DE); Martin Sicken, Koeln (DE)

(21) Appl. No.: 15/900,707

(22) Filed: Feb. 20, 2018

Related U.S. Application Data
(63) Continuation-in-part of application No. 14/773,147, filed on Sep. 4, 2015, now abandoned.

(30) Foreign Application Priority Data
Mar. 8, 2013 (DE) 10 2013 004 046.9

(51) Int. Cl. C08K 5/5313; C08L 77/06; C08K 7/14; C08K 3/40

(52) U.S. Cl. CPC C08K 5/5313; C08L 77/06; C08K 7/14; C08L 2205/03; C08K 2201/014; C08L 2201/02; C08L 2205/025; C08K 3/40

(57) ABSTRACT

The invention relates to a flame-retardant polyamide composition, containing as component A 1 to 96% by weight of one or more thermoplastic polyamides, as component B 2 to 25% by weight of dialkylphosphinic salt of the formula (I) and/or a diphosphinic salt of the formula (II) and/or the polymers thereof, wherein R1, R2 are the same or different C1-C6 alkyl, linear or branched or H: R3 C1-C10 alkylene, linear or branched, C6-C10 arylene, C7-C20 alkylarylene or C7-C20 arylalkylene; M Mg, Ca, Al, Sb, Sn, Ge, Ti, Zn, Fe, Zr, Ce, Bi, Sr, Mn, Li, Na, K and/or a protonized nitrogen base; m is 1 to 4; n is 1 to 4; x is 1 to 4, as component C 1 to 20% by weight salt of the phosphorous acid, as component D 1 to 50% by weight of filler or reinforcing material, as component E 0 to 2% by weight of a carboxyl ester amide, as component F 0 to 1% of a phosphonite or a mixture of a phosphonite and a phosphate, and as component G 0 to 1% by weight of an ester or salt of long-chain aliphatic carboxylic acids (fatty acids), which typically have chain lengths of C14 to C40, wherein the sum of the components is always 100% by weight.

This application is a continuation-in-part of U.S. patent application Ser. No. 14/773,147, which is hereby incorporated herein by reference in its entirety. application Ser. No. 14/773,147 is a national stage filing of International Patent Application no. PCT/EP2014/000515, which claims the benefit of priority of German Patent Application no. 10 2013 004 046.9.

The present invention relates to a flame-retardant polyamide composition, and also to moldings which comprise said flame-retardant polyamide composition.

The chemical composition of many plastics makes them readily combustible. Plastics generally have to be modified with flame retardants in order to meet the stringent flame-retardancy requirements demanded by plastics processors and sometimes by legislation. A wide variety of flame retardants and flame retardant synergists is known for this purpose, and is also available commercially. For some time, preference has been given to use of nonhalogenated flame retardant systems, because they have relatively advantageous ancillary properties in relation to smoke density and smoke composition in the event of a fire, and also for environmental reasons.

Among the nonhalogenated flame retardants, the salts of phosphinic acids (phosphinates) have proven to be particularly effective, in particular for thermoplastic polymers (DE-A-2 252 258 and DE-A-2 447 727). Some derivatives within this class of flame retardants are regarded as particularly useful because they have little adverse effect on the mechanical properties of the thermoplastic molding compositions.

Synergistic combinations of phosphinates with certain nitrogen-containing compounds, in particular with melamine derivatives, have moreover been found, and are more effective than the phosphinates alone as flame retardants in very many polymers (WO-A-2002/28953, WO-A-97/01664, and also DE-A-197 34 437, and DE-A-197 37 727).

It has moreover been found that the flame-retardant effect of the various phosphinates in thermoplastic polymers can also be markedly improved via additions of small quantities of inorganic/mineral compounds which comprise no nitrogen, and that said additions can also improve the flame-retardant effect of phosphinates in combination with nitrogen-containing synergists (EP-A-0 024 167, WO-A-2004/016684).

Use of phosphinate-containing flame retardant systems, in particular at processing temperatures above 300° C., was initially associated with polymer discoloration, partial polymer degradation, and fuming during processing. However, these problems could be mitigated via addition of basic or amphoteric oxides, hydroxides, carbonates, silicates, borates, or stannates (WO-A-2004/022640).

Thermoplastics are mainly processed in the melt. The associated changes of structure and of physical state cause alterations of chemical structure in almost all plastics. The result can be crosslinking, oxidation, molecular weight changes, and also concomitant changes in physical and technical properties. Various additives appropriate to each plastic are used in order to protect the polymers from adverse effects during processing.

A frequent practice is to use a variety of additives simultaneously, each of these having a particular function: antioxidants and stabilizers are used to avoid adverse chemical effects on the plastic during processing and to provide it with subsequent long-term resistance to exterior effects such as heat, UV light, weathering, and oxygen (air). Lubricants not only improve rheological properties but also prevent excessive adhesion of the plastics melt on hot machine components, and act as dispersing agents for pigments, fillers, and reinforcing materials.

The use of flame retardants can affect the stability of plastics during processing in the melt. It is frequently necessary to add large quantities of flame retardants in order to ensure adequate flame retardancy of the plastic in accordance with international standards. Because flame retardants have chemical reactivity, this being necessary for the flame-retardant effect at high temperatures, they can adversely affect the stability of plastics during processing. Possible results are by way of example crosslinking reactions, gas evolution, discoloration, or increased polymer degradation.

Polyamides, for example, are stabilized by small quantities of copper halides, and also by aromatic amines, and by sterically hindered phenols, the primary factor here being to achieve long-term stability at high long-term service temperatures (H. Zweifel (ed.): “Plastics Additives Handbook”, 5th edition, Carl Hanser Verlag, Munich, 2000, pages 80 to 84).

In particular when phosphorus-containing flame retardants are used in polyamides, the effect of the stabilizers described hitherto has proven to be inadequate, specifically for suppressing the effects such as discoloration and molecular weight degradation that occur during processing.

It was therefore an object of the present invention to provide halogen-free, flame-retardant, thermoplastic polyamide compositions (molding compositions) based on phosphinate-containing flame retardant systems, where these have high thermal stability and exhibit no migration effects but at the same time have good flowability and a high level of electrical properties (CTI>550V) and good flame retardancy (UL 94 V-0 extending to 0.4 mm).

Surprisingly, it has now been found that thermal stability in phosphinate-containing flame-retardant thermoplastic polyamides can be markedly improved, and tendency toward migration can be markedly reduced, if the molding composition comprises, in addition to the phosphinates (component B), a salt of phosphorous acid (also known as phosphonic acid) as component C. This specific combination also retains the balanced property profile of the polyamides in respect of electrical and mechanical properties. The polyamide composition (molding composition) moreover comprises fillers and/or reinforcing materials as component D. The polyamide composition of the invention can also comprise carboxylic (ester) amides as component E.

The polyamide composition of the invention can moreover comprise a phosphonite or a phosphonite/phosphite mixture as component F and an ester or a salt of long-chain aliphatic carboxylic acids (fatty acids) as component G, typical chain lengths of these carboxylic acids being from C₁₄ to C₄₀.

The invention therefore provides a flame-retardant polyamide composition comprising

as component A from 1 to 96% by weight of one or more thermoplastic polyamides, as component B from 2 to 25% by weight of a dialkylphosphinic salt of the formula (I) and/or of a diphosphinic salt of the formula (II) and/or polymers of these,

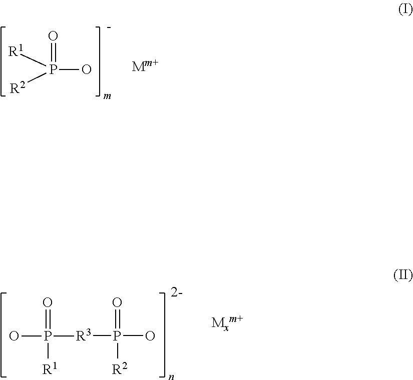

in which
R¹ and R² are identical or different and are C₁-C₆-alkyl, linear or branched or H;
R³ is C₁-C₁₀-alkylene, linear or branched, C₆-C₁₀-arylene, C₇-C₂₀-alkylarylene, or C₇-C₂₀-arylalkylene,
M is Mg, Ca, Al, Sb, Sn, Ge, Ti, Zn, Fe, Zr, Ce, Bi, Sr, Mn, Li, Na, K, and/or a protonated nitrogen base;
m is from 1 to 4;
n is from 1 to 4;
x is from 1 to 4,

as component C from 1 to 20% by weight of a salt of phosphorous acid,

as component D from 1 to 50% by weight of filler or reinforcing material,

as component E from 0 to 2% by weight of a carboxylic ester amide,

as component F from 0 to 1% by weight of a phosphonite or of a mixture of a phosphonite and a phosphite, and

as component G from 0 to 1% by weight of an ester or salt of long-chain aliphatic carboxylic acids (fatty acids) which typically have chain lengths of from C₁₄ to C₄₀, where the entirety of the components is always 100% by weight.

It is preferable that the flame-retardant polyamide composition comprises

from 15 to 91.9% by weight of component A,

from 5 to 20% by weight of component B,

from 2 to 10% by weight of component C,

from 1 to 50% by weight of component D,

from 0 to 2% by weight of component E,

from 0 to 2% by weight of component F, and

from 0.1 to 1% by weight of component G.

It is particularly preferable that the flame-retardant polyamide composition comprises

from 16 to 91.8% by weight of component A,

from 5 to 20% by weight of component B,

from 2 to 10% by weight of component C,

from 1 to 50% by weight of component D,

from 0 to 2% by weight of component E,

from 0.1 to 1% by weight of component F, and

from 0.1 to 1% by weight of component G.

With particular preference, the flame-retardant polyamide composition comprises

from 16 to 82.7% by weight of component A,

from 5 to 20% by weight of component B,

from 2 to 10% by weight of component C,

from 10 to 50% by weight of component D,

from 0.1 to 2% by weight of component E,

from 0.1 to 1% by weight of component F, and

from 0.1 to 1% by weight of component G.

Another preferred flame-retardant polyamide composition comprises

from 26 to 72.7% by weight of component A,

from 5 to 20% by weight of component B,

from 2 to 10% by weight of component C,

from 20 to 40% by weight of component D,

from 0.1 to 2% by weight of component E,

from 0.1 to 1% by weight of component F, and

from 0.1 to 1% by weight of component G.

It is preferable that the flame-retardant polyamide composition is one wherein the Comparative Tracking Index of said composition is greater than 550 volts, measured in accordance with the International Electrotechnical Commission standard IEC 60112/3.

The flame-retardant polyamide composition is also one wherein the UL 94 classification of said composition is V-0 at a thickness of from 3.2 mm to 0.4 mm.

It is preferable that the Glow Wire Flammability Index of the flame-retardant polyamide composition is 960° C. for a thickness of from 0.75 to 3 mm in accordance with IEC 60695-2-12.

It is preferable that the polyamide (PA) is selected from the group of PA 6, PA 6,6, PA 4,6, PA 12, PA 6,10, PA 6T/66, PA 6T/6, PA 4T, PA 9T, PA 10T, polyamide copolymers, polyamide blends, and combinations thereof.

It is preferable that component A is nylon-6,6 or a copolymer or polymer blend made of nylon-6,6 and nylon-6.

It is preferable that component A is composed of at least 75% by weight of nylon-6,6 and at most 25% by weight of nylon-6. In certain embodiments, component A is composed of at least 80% by weight of nylon-6,6 and at most 20% by weight of nylon-6.

It is also preferable that said composition is a blend of nylon-6,6 and of an amorphous, semiaromatic polyamide.

It is preferable that in the case of component B R¹ and R² are identical or different and are methyl, ethyl, n-propyl, isopropyl, n-butyl, tert-butyl, n-pentyl and/or phenyl.

It is preferable that in the case of component B R³ is methylene, ethylene, n-propylene, isopropylene, n-butylene, tert-butylene, n-pentylene, n-octylene, or n-dodecylene; phenylene, or naphthylene; methylphenylene, ethylphenylene, tert-butylphenylene, methylnaphthylene, ethylnaphthylene, or tert-butylnaphthylene; phenylmethylene, phenylethylene, phenylpropylene or phenylbutylene.

It is preferable that the salt of phosphorous acid (component C) of the formula (III) is

[HP(═O)O₂]²⁻M^{m+} (III)

in which M is Mg, Ca, Al, Sb, Sn, Ge, Ti, Zn, Fe, Zr, Ce, Bi, Sr, Mn, Li, Na, and/or K.

It is preferable that the salt of phosphorous acid (component C) is aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*xAl₂O₃*nH₂O, where x=2.27−1, and/or Al₄H₆P₁₆O₁₈.

It is also preferable that the salt of phosphorous acid (component C) is aluminum phosphite of the formulae (I), (II), and/or (III), where

formula (I) comprises Al₂(HPO₃)₃x(H₂O)_{q}, and q is from 0 to 4,

formula (II) comprises Al_{2.00}M_{z}(HPO₃)_{y}(OH)ᵥx(H₂O)_{w}, and M is alkali metal ions,

z is from 0.01 to 1.5, and y is from 2.63 to 3.5, and v is from 0 to 2, and w is from 0 to 4;

formula (III) comprises Al_{2.00}(HPO₃)ᵤ(H₂PO₃)ₜx(H₂O)ₛ, and u is from 2 to 2.99, and t is from 2 to 0.01, and s is from 0 to 4,

and/or is a mixture of aluminum phosphite of the formula (I) with sparingly soluble aluminum salts and with foreign nitrogen-free ions, a mixture of aluminum phosphite of the formula (III) with aluminum salts, or is aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*xAl₂O₃*nH₂O, where x=2.27−1, and/or Al₄H₆P₁₆O₁₈.

It is preferable that the average particle size of component C is from 0.2 to 100 μm.

It is preferable that the reinforcing filler is glass fibers.

It is preferable that component E is a derivative of an aromatic di- or tricarboxylic (ester) amide.

It is particularly preferable that component E is N,N′-bispiperidinyl-1,3-benzenedicarboxamide and/or N,N′-bis(2,2,6,6-tetramethyl-4-piperidinyl)-1,3-benzenedicarboxamide.

It is preferable that the phosphonites (component F) are those of the general structure

R—[P(OR₁)₂]ₘ (IV)

where
R is a mono- or polyvalent aliphatic, aromatic, or heteroaromatic organic moiety, and
R₁ is a system of the structure (V)

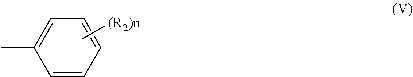

or the two moieties R₁ form a bridging group of the structure (VI)

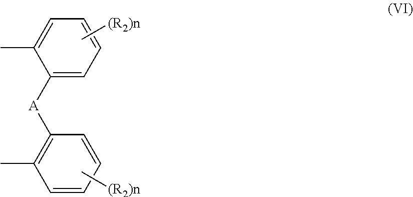

where
A is a direct bond, O, S, C₁-C₁₈-alkylene (linear or branched), or C₁-C₁₈-alkylidene (linear or branched),
   in which
R₂ is mutually independently C₁-C₁₂-alkyl (linear or branched), C₁-C₁₂-alkoxy, and/or C₅-C₁₂-cycloalkyl, and n is from 0 to 5, and m is from 1 to 4.

It is preferable that component G is alkali metal salts, alkaline earth metal salts, aluminum salts, and/or zinc salts of long-chain fatty acids having from 14 to 40 carbon atoms, and/or is reaction products of long-chain fatty acids having from 14 to 40 carbon atoms with polyhydric alcohols, for example ethylene glycol, glycerol, trimethylolpropane, and/or pentaerythritol.

The invention also provides a three-dimensional item comprising the flame-retardant polyamide composition as claimed in one or more of claims 1 to 23, wherein said item is a molding, injection-molded part, extruded composition, or extruded part.

Surprisingly, it has been found that the flame-retardant polyamide compositions of the invention have a good flame-retardant effect combined with improved thermal and hydrolytic stability. The addition of a carboxylic ester amide improves processing. Polymer degradation is prevented or very greatly reduced, and neither mold deposits nor efflorescence are/is observed. The flame-retardant polyamide compositions of the invention moreover exhibit only slight discoloration during processing in the melt.

In the invention, the compositions comprise at least one thermoplastic polyamide as component A.

With reference to Hans Domininghaus in “Die Kunststoffe and ihre Eigenschaften” [Plastics and their properties], 5th edition (1998), p. 14, the thermoplastic polyamides are polyamides whose molecular chains have no lateral branches, or else have lateral branches that vary in their length and in their number; these polyamides soften when heated and have almost unlimited moldability.

The polyamides that are preferred in the invention can be produced by various processes, and can be synthesized from a very wide variety of structural units, and for any specific application can be processed alone or in combination with processing aids or stabilizers, or else with polymeric alloy partners, preferably elastomers, to give materials with specifically adjusted combinations of properties. Other suitable materials are blends with content of other polymers, preferably of polyethylene, polypropylene, ABS, and it is optionally possible here to use one or more compatibilizers. The properties of the polyamides can be improved via addition of elastomers, e.g. in respect of impact resistance, in particular in the case of reinforced polyamides. The large number of possible combinations can provide a very large number of products with a very great variety of properties.

There are many known procedures for the production of polyamides, using various monomer units, various chain regulators for adjustment to a desired molecular weight, or else monomers having reactive groups for intended posttreatments, as required by the desired final product.

Most of the industrially significant processes for the production of polyamides proceed by way of polycondensation in the melt. The hydrolytic polymerization of lactams is also regarded here as polycondensation.

It is preferable to use, as component A, polyamides that are semicrystalline, where these can be produced by starting from diamines and dicarboxylic acids and/or lactams having at least five ring members, or corresponding amino acids.

Starting materials that can be used are aliphatic and/or aromatic dicarboxylic acids, preferably adipic acid, 2,2,4- and 2,4,4-trimethyladipic acid, azelaic acid, sebacic acid, isophthalic acid, terephthalic acid, aliphatic and/or aromatic diamines, preferably tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, preferably aminocaproic acid, or the corresponding lactams. Copolyamides made of a plurality of the monomers mentioned are included. It is particularly preferable to use caprolactams, and it is very particularly preferable to use [epsilon]-caprolactam.

Particularly suitable materials are moreover most of the compounded materials based on PA6, on PA66, and on other aliphatic or/and aromatic polyamides/copolyamides and having from 3 to 11 methylene groups for each polyamide group in the polymer chain.

It is preferable that the polyamides and copolyamides are nylon-12, nylon-4, nylon-4,6, nylon-6, nylon-6,6, nylon-6,9, nylon-6,10, nylon-6,12, nylon-6/6,6, nylon-7,7, nylon-8,8, nylon-9,9, nylon-10,9, nylon-10,10, nylon-11, nylon-12, etc. These are known by way of example with the trademarks Nylon®, DuPont, Ultramid®, BASF, Akulon® K122, DSM, Zytel® 7301, DuPont; Durethan® B 29, Bayer, and Grillamid®, Ems Chemie.

Other preferred suitable materials are aromatic polyamides derived from m-xylene, diamine, and adipic acid; polyamides produced from hexamethylenediamine and iso- and/or terephthalic acid, and optionally an elastomer as modifier, e.g. poly-2,4,4-trimethylhexamethyleneterephthalamide or poly-m-phenylenisophthalamide, block copolymers of the abovementioned polyamides with polyolefins, with olefin copolymers, with ionomers, or with chemically bonded or grafted elastomers, or with polyethers, e.g. with polyethylene glycol, polypropylene glycol, or polytetramethylene glycol. EPDM- or ABS-modified polyamides or copolyamides are also suitable; as also are polyamides condensed during processing (“RIM polyamide systems”).

In one preferred embodiment the compositions of the invention comprise, alongside the thermoplastic polyamide to be used in the invention, at least one other thermoplastic polymer, particularly preferably at least one other polyamide.

Preference is given to aliphatic polyamides, in particular PA6, PA66, PA 6T/66, and PA 6T/6. Very particular preference is given to mixtures of nylon-6,6 and nylon-6 where it is preferable that nylon-6,6 is >50% and that nylon-6 is <50%, and it is particularly preferable that nylon-6 is <25%, based in each case on the total quantity of polyamide.

Preference is also given to blends of nylon-6,6 and of one or more semiaromatic, amorphous polyamides.

In one preferred embodiment, conventional additives, in particular mold-release agents, stabilizers, and/or flow aids, can be admixed in the melt with, or applied on the surface of, the polymers that are to be used additionally alongside the thermoplastic polyamide. Starting materials for the thermoplastic polyamides of component A can derive from synthesis, e.g. from petrochemical feedstocks, and/or by way of chemical or biochemical processes from renewable feedstocks.

It is also possible to use other flame retardants or flame retardant synergists not specifically mentioned here. In particular, it is possible to add nitrogen-containing flame retardants such as melamine cyanurate, condensed melamine (melem, melon), or melamine phosphates and melamine polyphosphates. It is also possible to use other phosphorus flame retardants such as aryl phosphates, red phosphorus, or phosphazenes. It is moreover possible to use salts of aliphatic and aromatic sulfonic acids, and mineral flame retardant additives such as aluminum hydroxide and/or magnesium hydroxide, and Ca Mg carbonate hydrates (e.g. DE-A 4 236 122). It is also possible to use flame retardant synergists from the group of the oxygen-, nitrogen-, or sulfur-containing metal compounds, preferably zinc oxide, zinc borate, zinc stannate, zinc hydroxystannate, zinc sulfide, molybdenum oxide, titanium dioxide, magnesium oxide, magnesium carbonate, calcium carbonate, calcium oxide, titanium nitride, boron nitride, magnesium nitride, zinc nitride, zinc phosphate, calcium phosphate, calcium borate, magnesium borate, or a mixture of these.

Other flame retardant additives that are preferably suitable are carbonizing agents, particularly preferably phenol-formaldehyde resins, polycarbonates, polyimides, polysulfones, polyether sulfones, polyether ketones, and also antidripping agents, in particular tetrafluoroethylene polymers.

The flame retardants can be added in pure form, and also by way of masterbatches or compactates.

It is preferable that component B is the aluminum or zinc salt of diethylphosphinic acid.

In the case of the aluminum phosphite of the formula (I) it is preferable that q is from 0.01 to 0.1.

In the case of the aluminum phosphite of the formula (II) it is preferable that z is from 0.15 to 0.4; y is from 2.80 to 3; v is from 0.1 to 0.4, and that w is from 0.01 to 0.1.

In the case of the aluminum phosphite of the formula (III) it is preferable that u is from 2.834 to 2.99; t is from 0.332 to 0.03, and s is from 0.01 to 0.1.

In another preferred embodiment the flame-retardant polyamide compositions of the invention can comprise at least one filler or reinforcing material as component D.

It is also possible here to use mixtures of two or more different fillers and/or reinforcing materials, preferably based on talc, mica, silicate, quartz, titanium dioxide, wollastonite, kaolin, amorphous silicas, nanoscale minerals, particularly preferably montmorillonite or nanoboehmite, magnesium carbonate, chalk, feldspar, barium sulfate, glass beads, and/or fibrous fillers and/or reinforcing materials based on carbon fibers and/or glass fibers. It is preferable to use mineral particulate fillers based on talc, mica, silicate, quartz, titanium dioxide, wollastonite, kaolin, amorphous silicas, magnesium carbonate, chalk, feldspar, barium sulfate, and/or glass fibers. It is particularly preferable to use mineral particulate fillers based on talc, wollastonite, kaolin, and/or glass fibers, very particular preference being given to glass fibers here.

It is moreover also particularly preferable to use acicular mineral fillers. In the invention the expression acicular mineral fillers means a mineral filler with very pronounced acicular character. Preference may be given to acicular wollastonites. It is preferable that the length:diameter ratio of the mineral is from 2:1 to 35:1, particularly from 3:1 to 19:1, in particular from 4:1 to 12:1. It is preferable that the average particle size of the acicular minerals of the invention is less than 20 μm, particularly less than 15 μm, in particular less than 10 μm, determined with a CILAS granulometer.

In one preferred embodiment, the filler and/or reinforcing material can have been surface-modified, preferably with a coupling agent or coupling agent system, particularly preferably based on silane. However, the pretreatment is not essential. In particular when glass fibers are used, it is also possible to use polymer dispersions, film-formers, branching agents, and/or glass-fiber-processing aids, in addition to silanes.

The glass fibers to be used with very particular preference as component D in the invention, the fiber diameter of which is generally from 7 to 18 μm, preferably from 9 to 15 μm, are added in the form of continuous-filament fibers or in the form of chopped or ground glass fibers. These fibers can have been equipped with a suitable size system and with a coupling agent or coupling agent system, preferably based on silane.

The compositions of the invention can also comprise other additives. Preferred additives for the purposes of the present invention are antioxidants, UV stabilizers, gamma-radiation stabilizers, hydrolysis stabilizers, antistatic agents, emulsifiers, nucleating agents, plasticizers, processing aids, impact modifiers, dyes, and pigments. The additives can be used alone or in a mixture, or in the form of masterbatches.

Examples of suitable antioxidants are alkylated monophenols, e.g. 2,6-di-tert-butyl-4-methylphenol; alkylthiomethylphenols, e.g. 2,4-dioctylthiomethyl-6-tert-butylphenol; hydroquinones and alkylated hydroquinones, e.g. 2,6-di-tert-butyl-4-methoxyphenol; tocopherols, e.g. α-tocopherol, β-tocopherol, γ-tocopherol, δ-tocopherol, and mixtures thereof (vitamin E); hydroxylated thiodiphenyl ethers, e.g. 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl) disulfide; alkylidenebisphenols, e.g. 2,2′-methylenebis(6-tert-butyl-4-methylphenol; O-, N-, and S-benzyl compounds, e.g. 3,5,3′,5′-tetra-tert-butyl-4,4′-dihydroxydibenzyl ether; hydroxybenzylated malonates, e.g. dioctadecyl 2,2-bis(3,5-di-tert-butyl-2-hydroxybenzyl)malonate; hydroxybenzylaromatics, e.g. 1,3,5-tris(3,5-di-tert-butyl)-4-hydroxybenzyl-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl) phenol; triazine compounds, e.g. 2,4-bisoctylmercapto-6-(3,5-di-tert-butyl-4-hydroxyanilino)-1,3,5-triazine; benzyl phosphonates, e.g. dimethyl 2,5-di-tert-butyl-4-hydroxybenzylphosphonate; acylaminophenols, 4-hydroxylauramide, 4-hydroxystearanilide, octyl N-(3,5-di-tert-butyl-4-hydroxyphenyl)carbamate; esters of β-(3,5-di-tert-butyl-4-hydroxyphenyl)propionic acid with mono- or polyhydric alcohols; esters of β-(5-tert-butyl-4-hydroxy-3-methylphenyl)propionic acid with mono- or polyhydric alcohols; esters of β-(3,5-dicyclohexyl-4-hydroxyphenyl)propionic acid with mono- or polyhydric alcohols; esters of 3,5-di-tert-butyl-4-hydroxyphenylacetic acid with mono- or polyhydric alcohols; amides of β-(3,5-di-tert-butyl-4-hydroxyphenyl)propionic acid, for example N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

It is particularly preferable to use sterically hindered phenols alone or in combination with phosphites, and very particular preference is given to the use of N,N′-bis[3-(3′,5′-di-tert-butyl-4′-hydroxyphenyl)propionyl]hexamethylenediamine (e.g. Irganox® 1098 from BASF SE, Ludwigshafen, Germany).

Examples of suitable UV absorbers and light stabilizers are 2-(2′-hydroxyphenyl)benzotriazoles, for example 2-(2′-hydroxy-5′-methylphenyl)benzotriazole; 2-hydroxybenzophenones, for example the 4-hydroxy, 4-methoxy, 4-octoxy, 4-decyloxy, 4-dodecyloxy, 4-benzyloxy, 4,2′,4-trihydroxy, or 2′-hydroxy-4,4′-dimethoxy derivative;

esters of optionally substituted benzoic acids, for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate; acrylates, for example ethyl/isooctyl α-cyano-β,β-diphenylacrylate, methyl α-carbomethoxycinnamate, methyl/butyl α-cyano-β-methyl-p-methoxycinnamate, methyl α-carbomethoxy-p-methoxycinnamate, N-(β-carbomethoxy-β-cyanovinyl)-2-methylindoline.

Preferred colorants used are inorganic pigments, in particular titanium dioxide, ultramarine blue, iron oxide, zinc sulfide, or carbon black, and moreover organic pigments, preferably phthalocyanines, quinacridones, perylenes, and also dyes, preferably nigrosin and anthraquinones.

Examples of suitable polyamide stabilizers are copper salts in combination with iodides and/or phosphorus compounds; salts of divalent manganese are also suitable.

Suitable basic costabilizers are melamine, polyvinylpyrrolidone, dicyandiamide, triallyl cyanurate, urea derivatives, hydrazine derivatives, amines, polyamides, polyurethanes, the alkali metal and alkaline earth metal salts of higher fatty acids, for example Ca stearate, Zn stearate, Mg behenate, Mg stearate, Na ricinoleate, K palmitate, antimony pyrocatecholate, or tin pyrocatecholate.

Examples of suitable nucleating agents are 4-tert-butylbenzoic acid, adipic acid, and diphenylacetic acid, aluminum oxide and silicon dioxide, and also very particularly preferably talc powder, this list being non-exclusive.

It is preferable to use, as flow aids, copolymers of at least one α-olefin with at least one methacrylate or acrylate of an aliphatic alcohol. Particular preference is given here to copolymers in which the α-olefin is composed of ethene and/or propene and the methacrylate or acrylate comprises, as alcohol component, linear or branched alkyl groups having from 6 to 20 carbon atoms. Very particular preference is given to 2-ethylhexyl acrylate. A feature of copolymers that are suitable as flow aids in the invention is not only their composition but also low molecular weight. Accordingly, copolymers suitable for the compositions that are to be protected from thermal degradation in the invention are especially those having an MFI value of at least 100 g/10 min, preferably at least 150 g/10 min, particularly preferably at least 300 g/10 min, measured at 190° C. under a load of 2.16 kg. The MFI (melt flow index) serves to characterize the flow of a melt of a thermoplastic and is subject to the standards ISO 1133 and ASTM D1238. For the purposes of the present invention, MFI and all data relating to MFI are based on and/or were uniformly measured/determined in accordance with ISO 1133 at 190° C. with a test weight of 2.16 kg.

Plasticizers to be used are preferably dioctyl phthalate, dibenzyl phthalate, butyl benzyl phthalate, hydrocarbon oils, and N-(n-butyl)benzenesulfonamide.

However, the present invention also provides products, preferably fibers, foils, or moldings, obtainable via injection molding or extrusion from the compositions described in the invention.

Suitable phosphinates (component B) are described in PCT/WO97/39053, expressly incorporated herein by way of reference. Particularly preferred phosphinates are aluminum, calcium, and zinc phosphinates.

Preferred salts of phosphorous acid (component C) are salts that are insoluble in water or are sparingly soluble in water.

Particularly preferred salts of phosphorous acid are the aluminum, calcium, and zinc salts.

It is particularly preferable that component C is a reaction product of phosphorous acid and of an aluminum compound.

Preference is given to aluminum phosphites with the following CAS numbers: 15099-32-8, 119103-85-4, 220689-59-8, 56287-23-1, 156024-71-4, 71449-76-8, and 15099-32-8.

It is preferable that particle sizes of the aluminum phosphites are from 0.2 to 100 μm.

The preferred aluminum phosphites are produced via reaction of an aluminum source with a phosphorus source and if desired a template in a solvent at from 20 to 200° C. over a period of up to 4 days. For this, aluminum source and phosphorus source are mixed for from 1 to 4 h and heated under hydrothermal conditions or at reflux, and the solid is isolated by filtration and washed and dried at, for example, 110° C.

Preferred aluminum sources are aluminum isopropoxide, aluminum nitrate, aluminum chloride, aluminum hydroxide (e.g. pseudoboehmite).

Preferred phosphorus sources are phosphorous acid, (acidic) ammonium phosphite, alkali metal phosphites, or alkaline earth metal phosphites.

Preferred alkali metal phosphites are disodium phosphite, disodium phosphite hydrate, trisodium phosphite, potassium hydrogenphosphite.

Preferred disodium phosphite hydrate is ®Brüggolen H10 from Brüggemann.

Preferred templates are 1,6-hexanediamine, guanidine carbonate, and ammonia.

Preferred alkaline earth metal phosphite is calcium phosphite.

The preferred aluminum:phosphorus:solvent ratio here is from 1:1:3.7 to 1:2.2:100 mol. The aluminum:template ratio is from 1:0 to 1:17 mol. The preferred pH of the reaction solution is from 3 to 9. Preferred solvent is water.

It is particularly preferable that the phosphinic acid salt and the phosphorous acid salt used are the same, e.g. aluminum dialkylphosphinate together with aluminum phosphite or zinc dialkylphosphinate together with zinc phosphite.

It is preferable that component G is alkali metal salts, alkaline earth metal salts, aluminum salts, and/or zinc salts of long-chain fatty acids having from 14 to 40 carbon atoms, and/or is reaction products of long-chain fatty acids having from 14 to 40 carbon atoms with polyhydric alcohols, for example ethylene glycol, glycerol, trimethylolpropane, and/or pentaerythritol. It is particularly preferable that it is aluminum, calcium, or zinc stearate, or calcium montanate.

Other flame retardants are preferably aryl phosphates, phosphonates, hypophosphorous acid salts, or else red phosphorus.

In the case of the phosphonites preference is given to the following moieties:
R C₄-C₁₈-alkyl (linear or branched), C₄-C₁₈-alkylene (linear or branched), C₅-C₁₂-cycloalkyl, C₅-C₁₂-cycloalkylene, C₆-C₂₄-aryl and -heteroaryl, C₆-C₂₄-arylene and -heteroarylene, where these can also have further substitution;
R₁ being a system of the structure (V) or (VI), where
R₂ is mutually independently C₁-C₈-alkyl (linear or branched), C₁-C₈-alkoxy, cyclohexyl;
A is a direct bond, O, C₁-C₈-alkylene (linear or branched), C₁-C₈-alkylidene (linear or branched), and
n is from 0 to 3, and
m is from 1 to 3.

In the case of the phosphonites particular preference is given to the following moieties:
R cyclohexyl, phenyl, phenylene, biphenyl, and biphenylene,
R₁ being a system of the structure (V) or (VI), where
R₂ is mutually independently C₁-C₈-alkyl (linear or branched), C₁-C₈-alkoxy, cyclohexyl
A is a direct bond, O, C₁-C₆-alkylidene (linear or branched), and
n is from 1 to 3, and
m is 1 or 2.

Mixtures of compounds as per above claims are moreover claimed in combination with phosphites of the formula (VII)

P(OR₁)₃ (VII),

where the definitions of R₁ are those given above.

Preference is in particular given to compounds which, based on above claims, are produced via a Friedel-Crafts reaction of an aromatic or heteroaromatic such as benzene, biphenyl, or diphenyl ether with phosphorus trihalides, preferably phosphorus trichloride, in the presence of a Friedel-Crafts catalyst such as aluminum chloride, zinc chloride, iron chloride, etc., and subsequent reaction with the phenols underlying the structures (II) and (III). Materials expressly included here are also those mixtures with phosphites which arise after the reaction sequence mentioned from excess phosphorus trihalide and from the phenols described above.

Among this group of compounds, preference is in turn given to the following structures (VIII) and (IX):

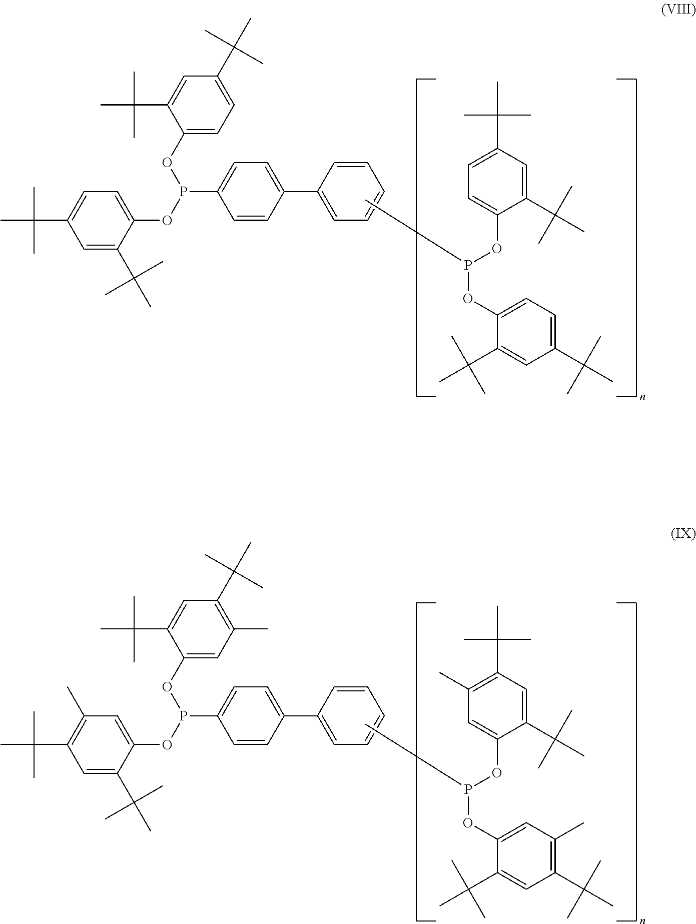

where n can be 0 or 1, and these mixtures can moreover also optionally comprise content of the compound (X) and, respectively, (XI):

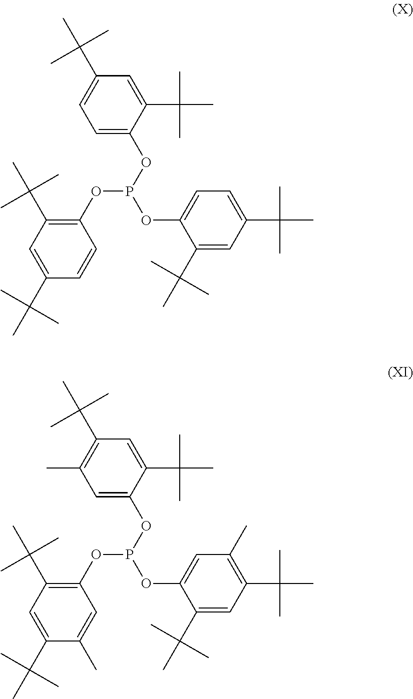

Suitable components G are esters or salts of long-chain aliphatic carboxylic acids (fatty acids) which typically have chain lengths of from C₁₄ to C₄₀. The esters are reaction products of the carboxylic acids mentioned with familiar polyhydric alcohols, for example ethylene glycol, glycerol, trimethylolpropane, or pentaerythritol. Salts that can be used of the carboxylic acids mentioned are especially alkali metal or alkaline earth metal salts, aluminum salts, and zinc salts.

It is preferable that component G is esters or salts of stearic acid, for example glycerol monostearate or calcium stearate.

It is preferable that component G is reaction products of montan wax acids with ethylene glycol.

It is preferable that the reaction products are a mixture of ethylene glycol mono-montan wax acid ester, ethylene glycol di-montan wax acid ester, montan wax acids, and ethylene glycol.

It is preferable that component G is reaction products of montan wax acids with a calcium salt.

It is particularly preferable that the reaction products are a mixture of 1,3-butanediol mono-montan wax acid ester, 1,3-butanediol di-montan wax acid ester, montan wax acids, 1,3-butanediol, calcium montanate, and the calcium salt.

The abovementioned additives can be introduced into the plastic in a very wide variety of steps of a process: in the case of polyamides it is possible to mix the additives into the polymer melt at the very beginning of the polymerization/polycondensation process, or at the end thereof, or in a subsequent compounding process. There are moreover processing methods which delay addition of the additives to a subsequent stage. This practice is used in particular when pigment masterbatches or additive masterbatches are used. There is moreover the possibility of application in a drum, in particular of pulverulent additives, to the polymer pellets, the temperature of which may possibly have been raised by the drying process.

Finally, the invention also provides a process for the production of flame-retardant polymer moldings which comprises processing flame-retardant polymer molding compositions of the invention via injection molding (e.g. in an Arburg Allrounder injection-molding machine) and pressing, foam injection molding, internal-gas-pressure injection molding, blow molding, film casting, calendering, lamination, or coating at relatively high temperatures to give the flame-retardant polymer molding.

Carbodiimides can also be present.

### EXAMPLE

### 1. Components Used

commercially available polyamides (component A):

nylon-6,6 (PA 6.6-GR): Ultramid® A27 (BASF AG, D)

nylon-6,T/6,6: Zytel® HTN FE 8200 (DuPont, USA)

nylon-6: Durethan® B29 (Lanxess AG, D)

nylon-6,T/6,I (amorphous): Grivory® G21, EMS Grivory, CH

nylon-6,10: Ultramid® S, BASF AG, D

flame retardant (component B):

aluminum salt of diethylphosphinic acid, hereinafter called DEPAL

flame retardant (component C):

aluminum salt of phosphorous acid, hereinafter called PHOPAL

comparison: MPP, melamine polyphosphate, Melapur® 200/70, BASF AG, D

component D:

PPG HP 3610 glass fibers, diameter 10 μm, length 4.5 mm (PPG, NL)

Aromatic di- or tricarboxylic esters/amides (component E):

Nylostab® S-EED (Clariant Produkte (Deutschland) GmbH, D)

(* Nylostab S-EED is N,N′-bis(2,2,6,6-tetramethyl-4-piperidyl)-1,3-benzenedicarboxamide)

phosphonites (component F):

Sandostab® P-EPQ, Clariant Produkte (Deutschland) GmbH, D

wax components (component G):

Licomont® CaV 102 (Ca salt of montan wax acid), Clariant Produkte (Deutschland) GmbH, D

Licowax® E (ester of montan wax acid), Clariant Produkte (Deutschland) GmbH, D

### 2. Production, Processing, and Testing of Flame-Retardant Polyamide Molding Compositions

The flame retardant components were mixed in the ratio stated in the table with the phosphonite, and with the lubricants and stabilizers, and incorporated by way of the side feed of a twin-screw extruder (Leistritz ZSE 27/44D) at temperatures of from 260 to 310° C. into PA 6.6 and, respectively, at from 250 to 275° C. into PA 6. The glass fibers were added by way of a second side feed. The homogenized polymer strand was drawn off, cooled in a water bath and then pelletized.

After adequate drying, the molding compositions were processed in an injection-molding machine (Arburg 320 C Allrounder) at melt temperatures of from 250 to 300° C. to give test specimens, and tested and classified for flame retardancy on the basis of the UL 94 test (Underwriters Laboratories).

The flowability of the molding compositions was determined via determination of melt volume index (MVR) for 275° C./2.16 kg. Higher MVR values mean better flowability in the injection-molding process. A sharp rise in MVR value can also, however, indicate polymer degradation.

All of the experiments of the present series were, unless otherwise stated, carried out under identical conditions for reasons of comparability (temperature programs, screw geometries, injection-molding parameters, etc.).

Inventive examples IE1-IE3 list the results where the flame retardant-stabilizer mixtures of the invention were used. All quantities are stated as % by weight and are based on the plastics molding composition inclusive of the flame retardants, additives, and reinforcing materials.

TABLE 1
PA 66 GF 30 Results of experiments. CE1-CE3 are
comparative examples, and IE1 to IE3 are polyamide
molding compositions of the invention

| | CE1 | CE2 | CE3 | IE1 | IE2 | IE3 |
|---|---|---|---|---|---|---|
| A: Nylon-6,6 | 49.55 | 49.55 | 49.55 | 49.55 | 39.55 | 49.30 |
| A: Nylon-6 | | | | | 10 | |
| D: HP3610 | 30 | 30 | 30 | 30 | 30 | 30 |
| glass fibers | | | | | | |
| B: DEPAL | 20 | 12 | 15 | 15 | 17 | 17 |
| C: PHOPAL | | | | 5 | 3 | 7 |
| MPP | | 8 | 5 | | | |
| E: SEED | | | | | | 0.25 |
| G: CaV 102 | 0.25 | 0.25 | 0.25 | 0.25 | 0.25 | 0.25 |
| F: P-EPQ | 0.20 | 0.20 | 0.20 | 0.20 | 0.20 | 0.20 |
| UL 94 0.4 mm | V-1 | V-0 | V-1 | V-0 | V-0 | V-0 |
| GWFI [° C.] | 850 | 960 | 960 | 960 | 960 | 960 |
| MVR 275° | 4 | 21 | 12 | 5 | 13 | 12 |
| C./2.16 kg | | | | | | |
| Efflorescence* | none | signif- | slight | none | none | none |
| | | icant | | | | |
| Color | white | gray | gray | white | white | white |
| Surface | rough | rough | rough | rough | smooth | smooth |
| CTI [volts] | 600 | 550 | 550 | 600 | 600 | 600 |
| Impact | 60 | 63 | 62 | 61 | 60 | 63 |
| resistance | | | | | | |
| [kJ/m²] | | | | | | |
| Notched impact | 12 | 11 | 12 | 12 | 12 | 14 |
| resistance | | | | | | |
| [kJ/m²] | | | | | | |

*14 days, 100% humidity, 70° C.

Only the combination of the invention of polyamide, glass fibers, DEPAL, and PHOPAL gives polyamide molding compositions which achieve the UL 94 fire classification V-0 at 0.4 mm and at the same time have CTI 600 volts, impact resistance greater than 60 kJ/m², notched impact resistance greater than 10 kJ/m², and exhibit no discoloration and no efflorescence. Addition of nylon-6 (inventive example IE2) and addition of Nylostab SEED (inventive example IE3) moreover produces better flowability (higher MVR) and a more attractive surface. Use of DEPAL without PHOPAL (CE1) does not achieve V-0, and although the combination of DEPAL with MPP achieves V-0 the polyamide molding composition exhibits discoloration and efflorescence. The CTI achieved is moreover not 600V.

TABLE 2
PA 6 GF 30 Results of experiments. CE4-CE6 are
comparative examples, and IE4 to IE7 are polyamide
molding compositions of the invention

| | CE4 | CE5 | CE6 | IE4 | IE5 | IE6 |
|---|---|---|---|---|---|---|
| A: Nylon-6 | 49.55 | 49.55 | 49.55 | 49.55 | 49.55 | 49.30 |
| D: HP3610 | 30 | 30 | 30 | 30 | 30 | 30 |
| glass fibers | | | | | | |
| B: DEPAL | 20 | 12 | 15 | 15 | 17 | 17 |
| C: PHOPAL | | | | 5 | 3 | 7 |
| MPP | | 8 | 5 | | | |
| E: SEED | | | | | | 0.25 |
| G: Wax E | 0.25 | 0.25 | 0.25 | 0.25 | 0.25 | 0.25 |
| F: P-EPQ | 0.20 | 0.20 | 0.20 | 0.20 | 0.20 | 0.20 |
| UL 94 0.4 mm | V-1 | V-0 | V-1 | V-1 | V-0 | V-0 |
| MVR 250° | 5 | 12 | 9 | 5 | 5 | 11 |
| C./2.16 kg | | | | | | |
| Efflorescence* | none | signif- | slight | none | none | none |
| | | icant | | | | |
| Color | white | gray | gray | white | white | white |
| Surface | rough | rough | rough | rough | rough | smooth |
| CTI [volts] | 600 | 550 | 500 | 600 | 600 | 600 |
| Impact | 61 | 59 | 60 | 63 | 63 | 65 |
| resistance | | | | | | |
| [kJ/m²] | | | | | | |
| Notched impact | 11 | 9.8 | 10 | 11 | 11 | 14 |
| resistance | | | | | | |
| [kJ/m²] | | | | | | |

*14 days, 100% humidity 70° C.

A similar picture is revealed by the experiments in nylon-6: only the combination of the invention of nylon-6 with glass fibers, DEPAL, PHOPAL, and SEED gives molding compositions which simultaneously have UL 94 V-0 at 0.4 mm, CTI 600V, no color changes and no efflorescence, good flowability, and good mechanical properties.

TABLE 3
Nylon-6, 6/6, T/6, I blends and nylon-6,10

| | CE7 | CE8 | IE7 | IE8 | IE9 | IE10 |
|---|---|---|---|---|---|---|
| A1: Nylon-6,6 | 35.55 | | 35.55 | | 34.30 | |
| A2: Nylon-6, T/6, I | 15 | | 15 | | 15 | |
| A3: Nylon-6,10 | | 49.55 | | 49.55 | | 49.30 |
| D: HP3610 glass fibers | 30 | 30 | 30 | 30 | 30 | 30 |
| B: DEPAL | 15 | 12 | 15 | 15 | 15 | 15 |
| C: PHOPAL | | | 5 | 5 | 5 | 5 |
| MPP | 5 | 8 | | | | |
| E: SEED | | | | | 0.25 | 0.25 |
| G: CaV 102 | 0.25 | 0.25 | 0.25 | 0.25 | 0.25 | 0.25 |
| F: P-EPQ | 0.20 | 0.20 | 0.20 | 0.20 | 0.20 | 0.20 |
| UL 94 0.4 mm | V-1 | V-0 | V-0 | V-0 | V-0 | V-0 |
| MVR 275° C./2.16 kg | 25 | 23 | 7 | 6 | 12 | 15 |
| Efflorescence* | significant | significant | none | none | none | none |
| Color | white | gray | white | white | white | white |
| Surface | rough | rough | rough | rough | smooth | smooth |
| CTI [volts] | 600 | 550 | 550 | 600 | 600 | 600 |
| Impact resistance [kJ/m²] | 60 | 65 | 62 | 61 | 60 | 63 |
| Notched impact resistance | 12 | 13 | 12 | 12 | 12 | 14 |
| [kJ/m²] | | | | | | |

*14 days, 100% humidity 70° C.

The picture revealed by the experiments in nylon-6,10 is similar to that for PA6: only the combination of the invention of nylon-6 with glass fibers, DEPAL, PHOPAL, and SEED gives molding compositions which simultaneously have UL 94 V-0 at 0.4 mm, CTI 600V, no color changes and no efflorescence, good flowability, and good mechanical properties.

In the blend of nylon-6,6 with an amorphous, semiaromatic polyamide (6T/6I), onset of decomposition, discernible from very high MVR, is observed with DEPAL+MPP. In contrast, the combination of the invention of DEPAL and PHOPAL exhibits no decomposition, UL 94 V-0, and CTI 600 V. Addition of SEED can improve flowability and surface quality.

TABLE 4
Experimental results from PA6T/66 GF 30

| | CE9 | CE10 | IE11 | IE12 |
|---|---|---|---|---|
| A: Nylon-6,T/6,6 | 57.55 | 54.55 | 57.55 | 54.30 |
| D: HP3610 glass fibers | 30 | 30 | 30 | 30 |
| B: DEPAL | 12 | 12 | 12 | 12 |
| MPP | | 3 | | |
| C: PHOPAL | | | 3 | 3 |
| D: SEED | | | | 0.25 |
| G: CaV 102 | 0.25 | 0.25 | 0.25 | 0.25 |
| E: P-EPQ | 0.20 | 0.20 | 0.20 | 0.20 |
| UL 94 0.8 mm | V-1 | n.d.* | V-0 | V-0 |
| CTI [V] | 600 | n.d.* | 600 | 600 |
| MVR 325° C./2.16 kg | 13 | n.d. | 8 | 17 |
| Impact resistance [kJ/m²] | 40 | n.d. | 45 | 47 |
| Notched impact resistance | 8 | n.d. | 12 | 13 |
| [kJ/m²] | | | | |

*Decomposition during extrusion, no polymer strand obtained

The DEPAL+MPP system cannot be used in nylon-6,T/6,6: severe decomposition is observed even before compounding has concluded. The polymer strand foams, and no pelletization is possible. In contrast, the polyamide of the invention with DEPAL, PHOPAL, and glass fibers provides good processing and achieves UL 94 V-0 and CTI 600 V. Here again, addition of SEED can improve flowability and surface quality.

1. A flame-retardant polyamide composition comprising
as component A from 1 to 96% by weight of one or more thermoplastic polyamides,
as component B from 2 to 25% by weight of a dialkylphosphinic salt of the formula (I) and/or of a diphosphinic salt of the formula (II) and/or polymers thereof, 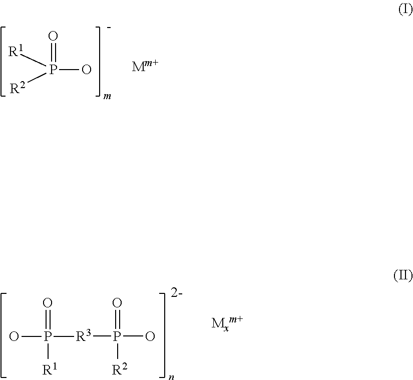
in which
R¹ and R² are identical or different and are C₁-C₆-alkyl, linear or branched or H;
R³ is C₁-C₁₀-alkylene, linear or branched, C₆-C₁₀-arylene, C₇-C₂₀-alkylarylene, or C₇-C₂₀-arylalkylene;
M is Mg, Ca, Al, Sb, Sn, Ge, Ti, Zn, Fe, Zr, Ce, Bi, Sr, Mn, Li, Na, K, and/or a protonated nitrogen base;
m is from 1 to 4;
n is from 1 to 4;
x is from 1 to 4,
as component C from 1 to 20% by weight of a salt of phosphorous acid,
as component D from 1 to 50% by weight of filler or reinforcing material,
as component E from 0 to 2% by weight of a carboxylic ester amide,
as component F from 0 to 1% by weight of a phosphonite or of a mixture of a phosphonite and a phosphite, and
as component G from 0 to 1% by weight of an ester or salt of long-chain aliphatic carboxylic acids (fatty acids) having chain lengths of from C₁₄ to C₄₀, where the entirety of the components is always 100% by weight.

2. (canceled)

3. The flame-retardant polyamide composition as claimed in claim 1, comprising
from 16 to 91.8% by weight of component A,
from 5 to 20% by weight of component B,
from 2 to 10% by weight of component C,
from 1 to 50% by weight of component D,
from 0 to 2% by weight of component E,
from 0.1 to 1% by weight of component F, and
from 0.1 to 1% by weight of component G.

4. The flame-retardant polyamide composition as claimed in claim 1, comprising
from 16 to 82.7% by weight of component A,
from 5 to 20% by weight of component B,
from 2 to 10% by weight of component C,
from 10 to 50% by weight of component D,
from 0.1 to 2% by weight of component E,
from 0.1 to 1% by weight of component F, and
from 0.1 to 1% by weight of component G.

5. The flame-retardant polyamide composition as claimed in claim 1, comprising
from 26 to 72.7% by weight of component A,
from 5 to 20% by weight of component B,
from 2 to 10% by weight of component C,
from 20 to 40% by weight of component D,
from 0.1 to 2% by weight of component E,
from 0.1 to 1% by weight of component F, and
from 0.1 to 1% by weight of component G.

6. The flame-retardant polyamide composition as claimed in claim 1, wherein
the Comparative Tracking Index of said composition is greater than 550 volts, measured in accordance with the International Electrotechnical Commission standard IEC 60112/3,
the UL 94 classification of said composition is V-0 at a thickness of from 3.2 mm to 0.4 mm, and
the Glow Wire Flammability Index of said composition is 960° C. for a thickness of from 0.75 to 3 mm in accordance with IEC 60695-2-12.

7-8. (canceled)

9. The flame-retardant polyamide composition as claimed in claim 1, wherein the polyamide (PA) is selected from the group consisting of PA 6, PA 6,6, PA 4,6, PA 12, PA 6,10, PA 6T/66, PA 6T/6, PA 4T, PA 9T, PA 10T, polyamide copolymers, polyamide blends, and combinations thereof.

10. The flame-retardant polyamide composition as claimed in claim 1, wherein component A is nylon-6,6 or a copolymer or polymer blend made of nylon-6,6 and nylon-6.

11. The flame-retardant polyamide composition as claimed in claim 1, wherein component A is composed of at least 75% by weight of nylon-6,6 and at most 25% by weight of nylon-6.

12. The flame-retardant polyamide composition as claimed in claim 1, wherein component A is a blend of nylon-6,6 and of an amorphous, semiaromatic polyamide.

13. The flame-retardant polyamide composition as claimed in claim 1, wherein R¹ and R² are identical or different and are methyl, ethyl, n-propyl, isopropyl, n-butyl, tert-butyl, n-pentyl and/or phenyl.

14. The flame-retardant polyamide composition as claimed in claim 1, wherein in the case of component B R³ is methylene, ethylene, n-propylene, isopropylene, n-butylene, tert-butylene, n-pentylene, n-octylene, or n-dodecylene; phenylene, or naphthylene; methylphenylene, ethylphenylene, tert-butylphenylene, methylnaphthylene, ethylnaphthylene, or tert-butylnaphthylene; phenylmethylene, phenylethylene, phenylpropylene or phenylbutylene.

15. The flame-retardant polyamide composition as claimed in claim 1, wherein the salt of phosphorous acid (component C) has the formula [HP(═O)O₂]²⁻M^{m+} in which M is Mg, Ca, Al, Sb, Sn, Ge, Ti, Zn, Fe, Zr, Ce, Bi, Sr, Mn, Li, Na, and/or K and m is a number sufficient to provide ionic balance.

16. The flame-retardant polyamide composition as claimed in claim 1, wherein the salt of phosphorous acid (component C) is aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*xAl₂O₃*nH₂O, where x=2.27−1, and/or Al₄H₆P₁₆O₁₈.

17. The flame-retardant polyamide composition as claimed in claim 1, wherein the salt of phosphorous acid is
aluminum phosphite of the formulae (I), (II), and/or (III), where
formula (I) is Al₂(HPO₃)₃x(H₂O)_{q}, q is from 0 to 4,
formula (II) is Al_{2.00}M_{z}(HPO₃)_{y}(OH)ᵥx(H₂O)_{w}, in which M is alkali metal ions, z is from 0.01 to 1.5, and y is from 2.63 to 3.5, and v is from 0 to 2, and w is from 0 to 4, and
formula (III) is Al_{2.00}(HPO₃)ᵤ(H₂PO₃)ₜx(H₂O)ₛ, in which u is from 2 to 2.99, and t is from 2 to 0.01, and s is from 0 to 4,
and/or is
a mixture of aluminum phosphite of the formula (I) with sparingly soluble aluminum salts and with foreign nitrogen-free ions, or
a mixture of aluminum phosphite of the formula (III) with aluminum salts,
or is
aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, or Al₂(HPO₃)³*xAl₂O₃*nH₂O, where x=2.27−1, and/or Al₄H₆P₁₆O₁₈.

18. The flame-retardant polyamide composition as claimed in claim 1, wherein the average particle size of component C is from 0.2 to 100 μm.

19. The flame-retardant polyamide composition as claimed in claim 1, wherein the reinforcing filler is glass fibers.

20. The flame-retardant polyamide composition as claimed in claim 1, wherein component E is a derivative of an aromatic di- or tricarboxylic (ester) amide.

21. The flame-retardant polyamide composition as claimed in claim 1, wherein component E is N,N′-bispiperidinyl-1,3-benzenedicarboxamide and/or N,N′-bis(2,2,6,6-tetramethyl-4-piperidinyl)-1,3-benzenedicarboxamide.

22. The flame-retardant polyamide composition as claimed in claim 1, wherein the phosphonites (component F) are those of the general structure R—[P(OR₁)₂]ₘ
where
R is a mono- or polyvalent aliphatic, aromatic, or heteroaromatic organic moiety, and
R₁ is a system of the structure 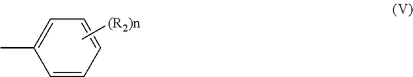
or the two moieties R₁ form a bridging group of the structure 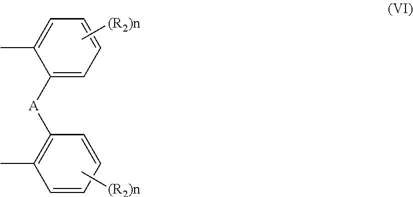
where
A is a direct bond, O, S, C₁-C₁₈-alkylene (linear or branched), C₁-C₁₈-alkylidene (linear or branched), and
R₂ is mutually independently C₁-C₁₂-alkyl (linear or branched), C₁-C₁₂-alkoxy, C₅-C₁₂-cycloalkyl, and n is from 0 to 5, and
m is from 1 to 4.

23. The flame-retardant polyamide composition as claimed in claim 1, wherein component G is alkali metal salts, alkaline earth metal salts, aluminum salts, and/or zinc salts of long-chain fatty acids having from 14 to 40 carbon atoms, and/or is reaction products of long-chain fatty acids having from 14 to 40 carbon atoms with polyhydric alcohols, for example ethylene glycol, glycerol, trimethylolpropane, and/or pentaerythritol.

24. The flame-retardant polyamide composition as claimed in claim 1, wherein said item is a molding, injection-molded part, extruded composition, or extruded part.

25. (canceled)
